(19) United States
(12) Patent Application Publication
(10) Pub. No.: US 2002/0041159 A1
(43) Pub. Date: Apr. 11, 2002

(54) Tongue jewelry with electrically energizable component

(76) Inventor: Dennis J. Kaping JR., San Diego, CA (US)

Correspondence Address: Foley & Lardner, Suite 2300, 402 West Broadway, San Diego, CA, 92101-3542, US

(21) Appl. No.: 09/784,857

(22) Filed: Feb. 14, 2001

Related U.S. Application Data
(63) Continuation-in-part of application No. 09/684,596, filed on Oct. 5, 2000.

(51) Int. Cl. H01J 7/44

(52) U.S. Cl. 315/56; 315/363

(57) ABSTRACT

An electrically-energizable tongue-engagable body decorative device for display in the mouth of a wearer may include an electrically energizable cap having a pair of housing portions being releasably attachable; and means for sealing together the housing portions in a liquid tight manner. There may be at least one electrically energizable component disposed within the housing portions for producing an aesthetically pleasing effect and battery means mounted within the housing portions for energizing the component when connected via a circuit thereto. Means may be provided for securing the electrically energizable cap removably from the tongue of the wearer. Also provided is a method for adorning a wearer with an aesthetically pleasing decorative ornamental device including securing an electrically-energizable tongue-engagable body decorative device to the tongue of the wearer and electrically energizing the device.

### CROSS-REFERENCE TO RELATED APPLICATIONS

This application is a continuation-in-part of pending U.S. application Ser. No. 09/684,596, filed Oct. 10, 2000, and claims priority of U.S. Provisional Application Ser. No. ______, filed Feb. 2, 2001, entitled “TONGUE JEWELRY WITH ELECTRICALLY ENERGIZABLE COMPONENT.”

### STATEMENT REGARDING FEDERALLY SPONSORED RESEARCH OR DEVELOPMENT

Not applicable

### REFERENCE TO A “MICROFICHE APPENDIX”

Not applicable

### BACKGROUND OF THE INVENTION

1. Field of the Invention

The present invention relates generally to jewelry for internal use, and more specifically to jewelry that is electrically energizable and engagable in the tongue.

2. Related Art

A variety of approaches for making an electrically energized light-transmissive ornament to illuminate jewelry such as earrings, necklaces, bracelets, pendants and other decorative ornaments have been described in the art (see, e.g., U.S. Pat. No. 5,876,109, 4,605,882 and 5,201,578). There is increasing interest in jewelry that is worn by piercing a body part such as the tongue (e.g., a tongue stud). However, the inventors are not familiar with a description of electrically energized jewelry suitable for attachment to the tongue.

There are barriers to the internal use of electrically energizable jewelry. First and foremost are issues about the safety; the wearer of energizable jewelry should be protected from exposure to the energy source (e.g., a battery). The design also should provide a simple means of connecting and disconnecting the power source. There should be easy access to the power source for replacement purposes. Also, the overall design must be sufficiently small enough to maintain its aesthetic value as jewelry while functioning effectively in its energized mode. Thus, energizable jewelry engagable to the tongue would be desirable if such barriers could be overcome.

### SUMMARY OF THE INVENTION

The present invention is directed to solving the problem alluded to above, by providing an electrically-energizable tongue-engagable body decorative device for display in the mouth of a wearer. The device may include means for securing a housing removably from the tongue of the wearer; at least one electrically energizable component disposed within the housing for producing an aesthetically pleasing effect; and battery means mounted within the housing for energizing said component when connected via a circuit thereto the housing has a pair of portions releasably attachable, and sealed together in a liquid tight manner.

In another embodiment, the housing pair portions may be at least partially composed of translucent plastic material.

In yet another embodiment, the energizable component may include at least one illuminating element for providing a decorative light source and the housing portion located between the illuminating element and an observer may be translucent or transparent. The illuminating element may be a light emitting diode.

In yet another embodiment, the housing may include an electrical element that controls current to the electrically energizable component. The electrical element may be a flasher that controls current to said at least one illuminating element.

In still yet another embodiment, the energizable component may be a vibrator.

In a further embodiment, the decorative device may be secured to the tongue by a post extending through an opening in the tongue of the wearer and a cap releasably secured to one end of said post. The post can be straight or curved. In an alternative embodiment, the device may be secured to the surface of the tongue by a suction element.

In yet a further embodiment, the circuit of the device may include a housing internal annular conductor for engaging electrically the outer surface of the battery means to provide an electrical ground connection for the electrically energizable component. The circuit may include a printed circuit board and also an annular ground conductor on the underside of the circuit board that engages electrically a housing internal annular conductor.

In still yet another embodiment, the housing portions of the decorative device may be sealed together in a liquid tight manner by an O-ring.

In another embodiment, the housing portions may be releasably attachable by annular threading.

Also, the device of the present invention may be an electrically-energizable cap of an electrically-energizable tongue-engagable device for display in the mouth of a wearer. The energizable cap may be secured in the tongue by attachment to a post, and includes a housing having a pair of portions being releasably attachable; means for sealing together the housing portions in a liquid tight manner; and may include at least one electrically energizable component disposed within the housing for producing an aesthetically pleasing effect with battery means mounted within the housing for energizing the component when connected via a circuit thereto; and means for attaching the energizable cap to a post.

Further provided herein is a method of adorning the tongue of a wearer with an aesthetically pleasing decorative ornamental device, which may include securing an electrically-energizable tongue-engagable body decorative device to the tongue of the wearer and electrically energizing the device.

### BRIEF DESCRIPTION OF THE DRAWINGS

The various features and advantages of the present invention will become more clearly appreciated as a detailed description of the preferred embodiment is given with reference to the appended drawings in which;

FIG. 1 is perspective view of a straight line tongue stud design embodiment of the invention depicting in cross-section, the housing containing the electrically energizable illuminating component;

FIG. 2 is a view similar to that shown in FIG. 1 but differs in the means for anchoring the energizable housing to the jewelry;

FIG. 3 is a view similar to that shown in FIG. 1 but differs in the means for anchoring the energizable housing to the jewelry;

FIG. 4 is perspective view of a straight line tongue stud embodiment of the invention depicting in cross-section, the housing containing an electrically energizable vibrating component;

FIG. 5 is a perspective view of curved tongue stud embodiment of the invention containing the electrically energizable component.

FIG. 6 is a cross-sectional view of another embodiment of the electrically energizable component according to the invention in an off position.

FIG. 7 is a cross-sectional view of the electrically energizable component shown in FIG. 6 in an on position.

### DETAILED DESCRIPTION OF THE PREFERRED EMBODIMENTS

The present invention provides an electrically-energizable tongue-engagable body decorative device for display in the mouth of a wearer, comprising:

(a) an electrically energizable cap comprising: a housing having a pair of portions being releasably attachable; means for sealing together said housing portions in a liquid tight manner; at least one electrically energizable component disposed within the housing for producing an aesthetically pleasing effect; battery means mounted within the housing for energizing the component when connected via a circuit thereto; and

(b) means for securing the electrically energizable cap removably from the tongue of the wearer. The present invention also provides an electrically-energizable cap comprised as described above and secured in the tongue by attachment to a post or a solid cap.

The housing can be constructed of thermoplastic or other translucent plastic material or it can be constructed of metal that is suitable for internal use (e.g. stainless steel). In the latter case, the electrical circuit is preferably insulated from the metal housing.

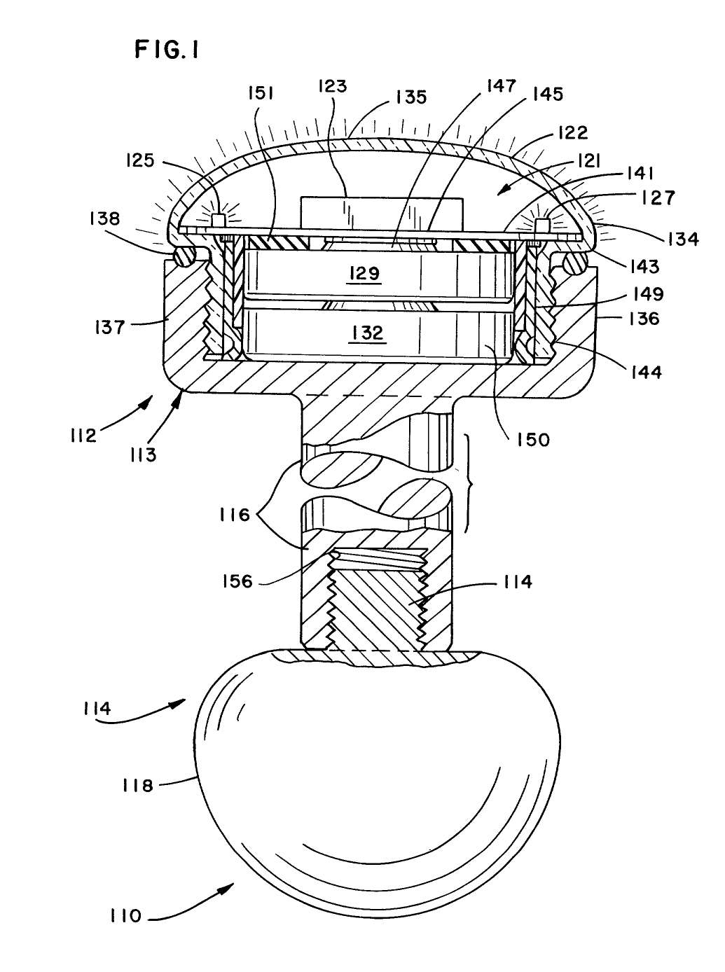

FIGS. 1-5 show various embodiments of the invention. FIG. 1 depicts the electrically-energizable tongue-engagable decorative device 10. The device comprises electrically-energizable cap 112 comprising a housing generally indicated as 113 and including an electrically energizable component 121. The latter includes an electrical element in the form of a flasher 123 and an illuminating element in the form of a light emitting diode (“LED”) 125 and 127. The flasher 123 can be used to power the illuminating element(s) 125, 127 and to control the pattern of current that is sent to the illuminating element(s) 125, 127.

The curved top portion 122 of top housing portion 134 should be made of translucent or transparent material to allow an observer to see visible light emanating from the LEDs. It would be understood that the LED's or other illuminating elements can emit a colored light and that multiple LED's or other illuminating elements can be used to emit a variety of colored lights from a single device.

The housing comprises a top housing portion 134 having a hollow interior 135, and a post housing portion 136 having a hollow interior 137. Batteries 129 and 132 are contained within top post housing portion 136. An O-ring 138 is located between the top housing portion 134 and the post housing portion 136 within complementary shaped C-shaped confronting recesses therein, to provide a liquid-tight seal separating the interior contents of the top housing 134 and post housing 136 from the outside environment.

The top housing portion in FIG. 1 includes a printed circuit board 141 connecting to flasher 123 and resting on an annular shoulder portion 143. Terminal 147 of battery 129 contacts terminal conductor 145 on underside of circuit board 141 when the top housing portion 134 is fully engaged by screwing threads 144 of annular support 143 into threaded bore 137 of post housing portion 136.

Annular conductor 152 located on the underside of printed circuit board 141 electrically contacts the circuit board as well as the internal annular conductor 149, the latter engaging electrically the outer surface 150 of batteries 129 and 132. Annular resilient washer 151 is used for seating and for disconnecting the batteries by threading or unthreading the housing portions. An electrical circuit is formed when current from the terminal conductor 147 of battery 129 passes to flasher 123 and then to LEDs 123 and 125 by way of printed circuit board 141, and returns to battery 132 by way of annular conductor 152 (located on the underside of printed circuit board 41) and housing internal annular conductor 149. Other circuit designs, however, can readily be employed.

In FIG. 1, the housing 113 is engaged in the tongue of a wearer by securing arrangement 114. The latter comprises a post 116 forming an integral part of the cap 112, and solid cap 118, the solid cap having a threaded stud 154 that engages an internally threaded bore 156 of post 116. Engagement is accomplished by inserting the housing with attached post and internally threaded bore 156 through a hole in the tongue. The housing-post is secured in place in the tongue by threadably screwing the threaded stud 154 of solid cap 118 into the threaded bore 156 of post 118.

The post housing portion 136 is preferably composed of suitable conductive metal material, or non-conductive plastic or other suitable material. For example, titanium or other non-conductive metal, or other non-conductive materials, may be employed. The top housing portion 134 may be composed, at least partially of suitable plastic material, such as dental acrylic.

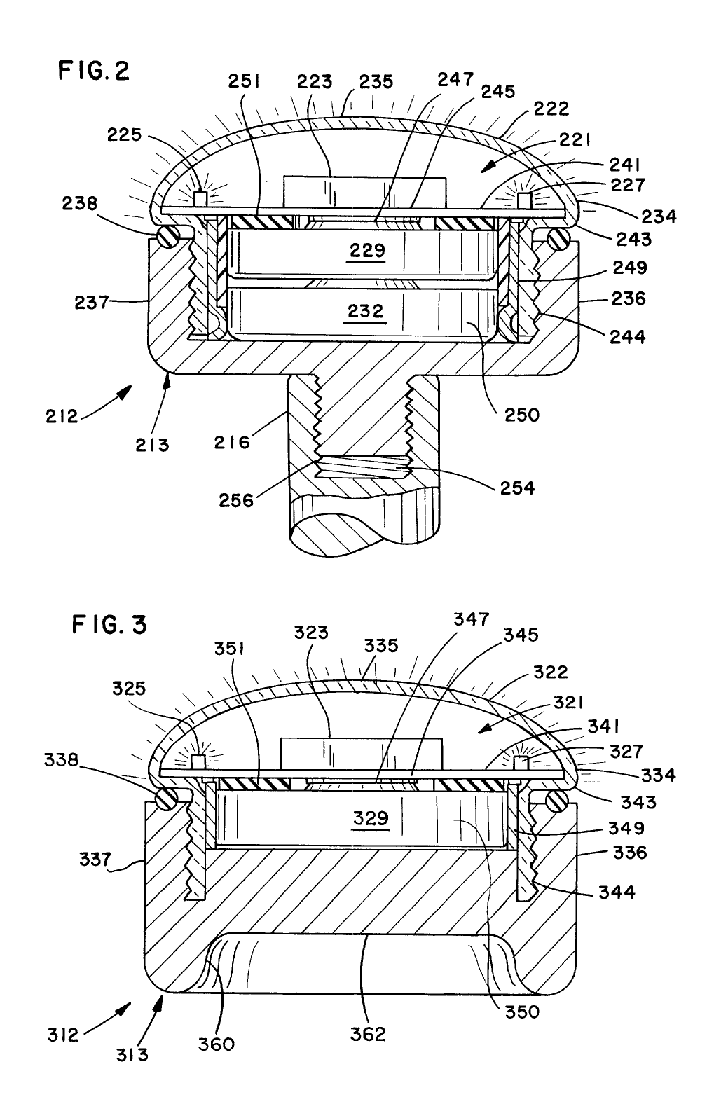

The electrically-energizable tongue-engagable body decorative device of FIG. 2 is the same as in FIG. 1 except for the securing arrangement means (note that the numbered component parts of FIG. 1 correspond to the 200 series numbered component parts of FIG. 2). In FIG. 2, threaded stud 254 is formed as part of housing 212. Post 216 which is attached on one end to cap (not shown) has on its other end, internally threaded bore 256. Engagement is accomplished by inserting the post with internally threaded bore 256 through a hole in the tongue and securing the post in place by screwing the threaded stud 254 of housing 212 into the threaded bore 256 of post 216.

The electrically-energizable tongue-engagable body decorative device of FIG. 3 is the same as in FIG. 1 except for the securing arrangement means (note that the numbered component parts of FIG. 1 correspond to the 300 series numbered component parts of FIG. 3). In FIG. 3, the tongue securing arrangement comprises a suction element 314 having tubular exterior 360 of housing 313 and a recessed central portion 362 for engaging the tongue of the wearer by suction.

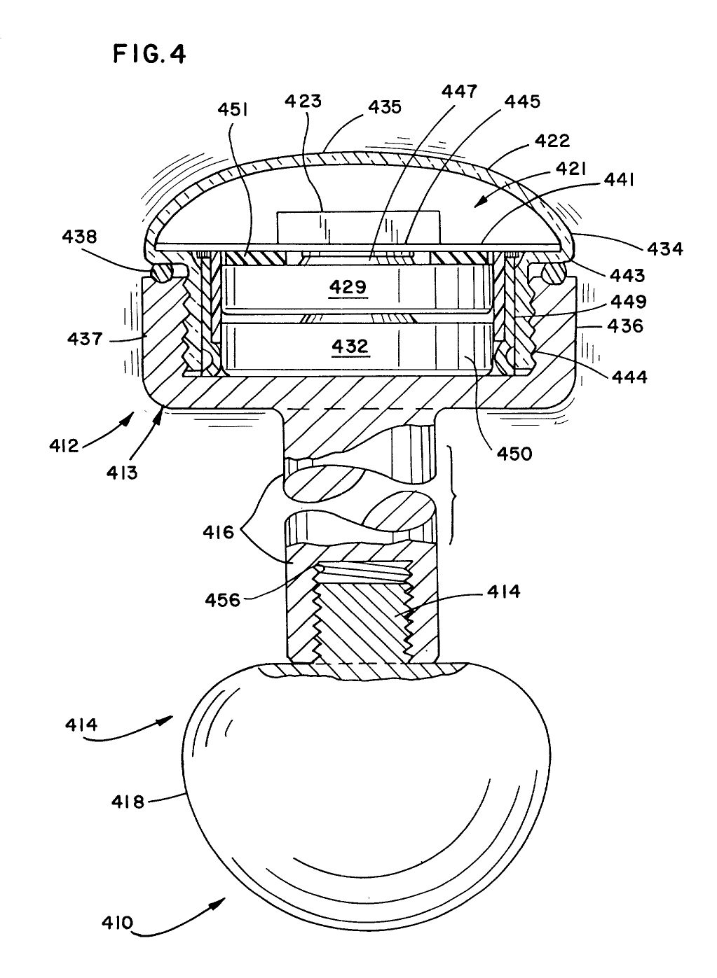

The electrically-energizable tongue-engagable body decorative device of FIG. 4 is the same as in FIG. 1 except for the electrically energizable component (note that the numbered component parts of FIG. 1 correspond to the 400 series numbered component parts of FIG. 4). In FIG. 4, the electrically energizable component 421 includes a vibrator 423 and does not have LEDs. However, it would be understood that one can readily combine a vibrator with one or more illuminating elements such as an LED in a single device if desired.

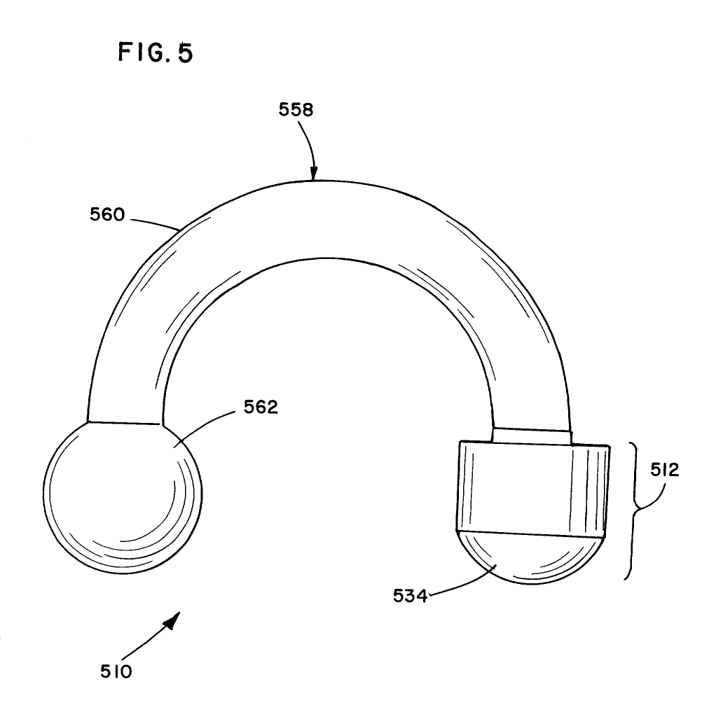

FIG. 5 shows an electrically-energizable tongue-engagable body decorative device 558 having an electrically-energizable cap 512 having top housing portion 534. Cap 512 is attached to curved post 560, the latter connecting to solid cap 562. It is understood by those skilled in the art that cap 512 can be attached to a variety of different shaped tongue-piercing posts (see, e.g. U.S. Pat. No. 5,946,943 to Hansen).

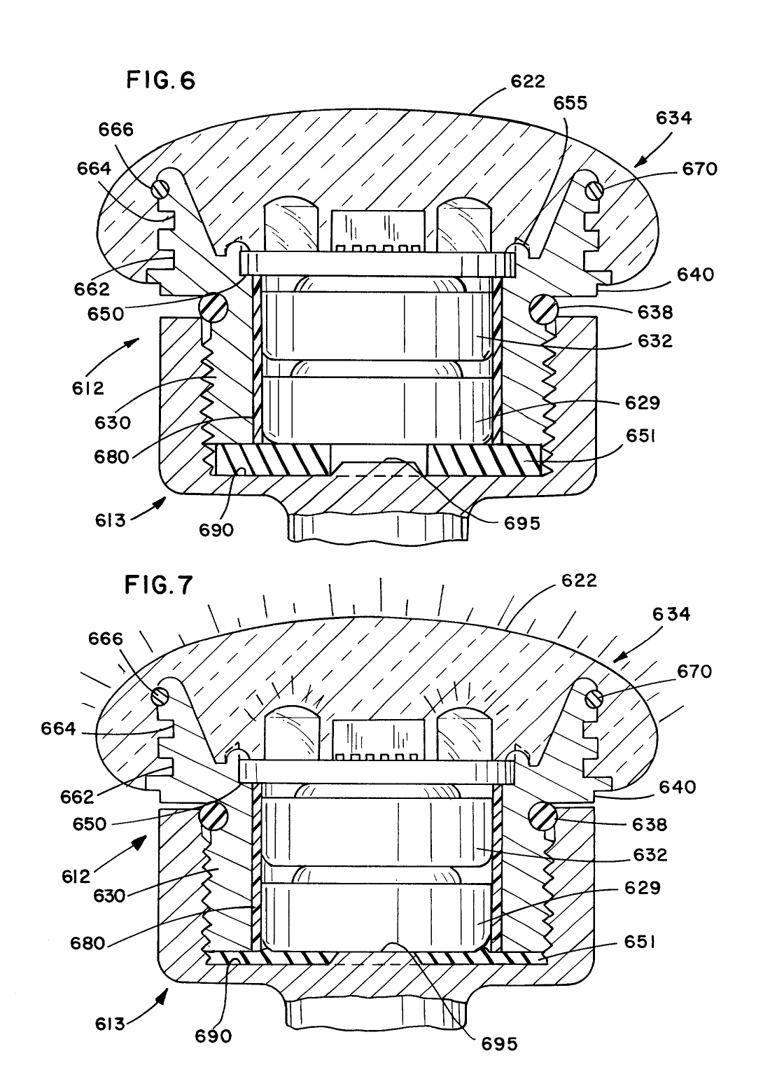

FIGS. 6 and 7 illustrate another embodiment of the invention. Similar to the embodiment illustrated in FIG. 1, FIG. 6 illustrates a cap 612 for an electrically-energizable tongue-engagable decorative device. The cap 612 comprises a lower housing 613 and an upper housing 634. The lower housing 613 is formed as a cylinder with a hollow interior, a solid base 690 and an open top. The internal wall of the hollow cylinder is threaded to threadably engage the upper housing 634 (described below). The solid base 690 comprises a protrusion in its central region extending inward. Although FIG. 6 illustrates the protrusion as frustum conical in shape, any number of shapes may be used. The lower housing 613 is made of a conductive material to allow the flow of electrical current.

The upper housing 634 comprises a cylindrical engagement portion 630 with a hollow interior, a non-engagement portion 640, and a decorative top 622. The engagement portion 630 has an outer wall that is sized and threaded to engage the internal wall of the hollow cylinder of the lower housing 613. The hollow interior of the engagement portion 630 is sized to house batteries. In one embodiment, two “button” batteries 629, 632 are housed in the hollow interior.

The upper housing 634 also has a ledge 650 formed in its top to accommodate a printed circuit board 641. As noted above with reference to FIG. 1, the printed circuit board may comprise electrically-energizable components such as LEDs or vibrators. An annular flange 655 in the upper housing 634 is crimped inward and downward to at least partially secure the peripheral printed circuit board 641 to the ledge 650 of the upper housing 634.

The non-engagement portion 640 of the upper housing 634 has an outer diameter that is larger than that of the engagement portion 630. The non-engagement portion 640 has annular grooves 662, 664, 666 formed along its outer wall. In the embodiment illustrated in FIGS. 6 and 7, three annular grooves are provided.

The engagement portion 630 and the non-engagement portion 640 of the upper housing 634 are made of a conductive material that allows the flow of electrical current. A layer of non-conductive insulation 680 is provided along the inner wall of the engagement portion 630. This insulation 680 prevents electrical contact between the batteries 629, 632 and the conductive material of the engagement portion 630, thereby preventing the circuit from bypassing the switch function described below with reference to the spacing ring 651.

The non-engagement portion 640 of the upper housing 634 is enveloped by a decorative top 622. The decorative top 622 is made of an at least partially transparent, non-conductive material such as acrylic. The decorative top 622 is preferably molded onto the non-engagement portion 640. The molding may be performed by any conventional molding process such as injection molding. Once the decorative top 622 is molded, the annular grooves 662, 664, 666 in the non-engagement portion 640 act to further secure the molding to the upper housing 634 and help to reduce the possibility of leakage of moisture into the interior of the device.

A spacing ring 651 is provided within the hollow portion of the lower housing 613. The ring 651 encircles the protrusion 695 in the solid base 690 of the lower housing 613. The ring 651 is made of an elastometric material that compresses when pressure is applied and expands to its original size and shape when the pressure is removed. FIG. 6 illustrates the spacing ring 651 in its uncompressed form (i.e., with no pressure being applied). The uncompressed height of the ring is greater than the depth of the protrusion 695. FIG. 7 illustrates the spacing ring 651 with pressure applied from the upper housing 634, compressing the ring to a depth less than or equal to that of the protrusion 695. Thus, the spacing ring 651 helps to provide a switch function to control the flow of current from the battery 629 to the protrusion 695. The spacing ring 651 also functions as a seal to prevent moisture from seeping from the outside environment to the batteries 629, 632.

Thus, when the upper housing 634 is sufficiently threaded into the lower housing 613, the battery 629 is forced into contact with the protrusion 695. Electrical current then flows from the batteries 629, 632, through the protrusion 695 and the conductive lower housing 613, to the conductive upper housing 634, and to a contact point in the circuit board 641. When the upper housing 634 is sufficiently threaded out of the lower housing 613, the expansion of the ring 651 forces the battery 629 away from the protrusion 695, thereby breaking the electrical circuit.

An O-ring 638 is provided around the upper housing 634 at its junction with the upper end of the lower housing 613. The O-ring 638 provides a liquid-tight seal and prevents moisture from the mouth from seeping into the threaded region and to the batteries 629, 632. The O-ring 638 is sized such that the seal is formed even when the upper housing 634 is partially threaded out of the lower housing 613 to break the circuit between the battery 629 and the protrusion 695 (as described above). Thus, the O-ring 638 helps provides a moisture-free environment for the batteries 629, 632 whether the circuit is in its open or closed positions.

A second O-ring 670 may be provided between the non-engagement portion 640 of the upper housing 634 and the molded decorative top 622. Preferably, the second O-ring 670 is located within the uppermost annular groove 666 of the non-engagement portion 640. This O-ring 670 provides protection against moisture in the event that the molded decorative top 622 becomes delaminated from the upper housing 634. Delamination may occur if the wearer of the device accidentally bites the decorative top with great force or other such sufficient external force is applied to the device. In the event of delamination, moisture may seep from the outside environment, through the interface between the decorative top 622 and the non-engagement portion 640, and onto the printed circuit board 641. The second O-ring 670 helps form a liquid-tight seal between the outside environment and the printed circuit board 641 in such a case.

Also provided herein is a method of adorning the tongue of a wearer with an aesthetically pleasing decorative ornamental device including securing an electrically-energizable tongue-engagable body decorative device to the tongue of the wearer and electrically energizing the device.

What is claimed is:

1. An electrically-energizable cap of a tongue-engagable device for display in the mouth of a wearer, said energizable cap to be secured in the tongue by attachment to a post, comprising:
a lower housing having a hollow interior, said hollow interior having an inner wall and a solid base, said solid base having a protrusion;
an upper housing having an engagement portion, said engagement portion having an external wall for engaging said inner wall of said lower housing, said engagement portion also having a hollow interior adapted to receive a power source;
a spacer element adapted to separate said solid base of said lower housing from said engagement portion of said upper housing, said spacer element adapted to allow contact between said power source and said protrusion when said upper housing and said lower housing are sufficiently engaged; and
a decorative top enveloping at least a portion of said upper housing,
wherein said upper housing has at least one electrically-energizable component.

2. An electrically-energizable cap according to claim 1, wherein said lower housing and said upper housing are composed of thermoplastic material.

3. An electrically-energizable cap according to claim 1, wherein said electrically-energizable component includes at least one illuminating element for providing a decorative light source and wherein said decorative top is translucent or transparent.

4. An electrically-energizable cap according to claim 3, wherein said at least one illuminating element is a light emitting diode.

5. An electrically-energizable cap according to claim 1, wherein said electrically-energizable component is a vibrator.

6. An electrically-energizable cap according to claim 1, wherein said spacer element is an annular ring surrounding said protrusion.

7. An electrically-energizable cap according to claim 1, wherein said inner wall of said lower housing and said outer wall of said upper housing are threaded for engagement with each other.

8. An electrically-energizable cap according to claim 1, wherein said upper housing comprises an annular flange adapted to secure a circuit board to said upper housing when said annular flange is crimped onto said circuit board.

9. An electrically-energizable cap according to claim 1, wherein said upper housing comprises a non-engagement portion having a ledge adapted to support a printed circuit board.

10. An electrically-energizable cap according to claim 9, wherein said non-engagement portion has annular grooves formed on an outer wall, said annular grooves being adapted to partially secure said decorative top to said upper housing.

11. An electrically-energizable cap according to claim 1, wherein said decorative top is molded around at least a portion of said upper housing.

12. A housing for an electrically-energizable cap of a tongue-engagable device for display in the mouth of a wearer, said housing comprising:
an engagement portion, said engagement portion having an external wall for engaging an inner wall of a lower housing, said engagement portion also having a hollow interior adapted to receive a power source;
a decorative top enveloping at least a portion of said upper housing; and
at least one electrically-energizable component, said component being mounted on said engagement portion and being enveloped by said decorative top.
